(19) United States
(12) Patent Application Publication
(10) Pub. No.: US 2010/0068104 A1
(43) Pub. Date: Mar. 18, 2010

(54) Flat-Type Non-Thermal Plasma Reactor

(76) Inventor: Seock Joon Kim, Daejeon-city (KR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/226,304

(22) PCT Filed: Dec. 9, 2006
(86) PCT No.: PCT/KR2006/005568

§ 371 Date: Sep. 28, 2009

(30) Foreign Application Priority Data
May 4, 2006 (KR) 10-2006-0040275

(51) Int. Cl. B01J 19/08; F01N 3/00; B01D 53/32; G05B 9/02

(52) U.S. Cl. 422/117; 422/186.04

(57) ABSTRACT

Disclosed is a flat-type non-thermal plasma reactor treating harmful gases, which can greatly improve durability against thermal stress, and stably generate low-temperature plasma in an environment in which gases to be treated for a vehicle has a wide variation range of temperature and a great variation volume with respect to a time, individually provide electrode leads of the high-voltage electrode stack section to high-voltage electrode plates, intercept overcurrent such as arc resulting from abnormal discharge by means of a fuse installed to each electrode terminal, prevent electric power from being supplied to a plasma layer in which an insignificant problem occurs as long as there is no problem of overall performance, and thus extend a lifetime of the flat-type non-thermal plasma reactor.

### TECHNICAL FIELD

The present invention relates to a dielectric barrier discharge flat-type non-thermal plasma reactor treating harmful gases, and more particularly to a flat-type non-thermal plasma reactor, in which a voltage applying section is separated from a grounding section, thereby minimizing a possibility of losing performance of the flat-type non-thermal plasma reactor due to thermal stress that can be caused in an environment where thermal load is greatly changed when a conventional integrated flat-type non-thermal plasma reactor is used, and thus improving thermal stress resistant performance.

### BACKGROUND ART

In general, a non-thermal plasma reactor can obtain a relatively clean environment based on well-treated gases, such as nitrogen, air, helium, argon, and the like, for generating active radicals, as well as excellent performance in a harmful gas treatment process of treating air and exhaust gases that are rich in moisture and particulate. The non-thermal plasma reactor can be satisfied by a flat-type non-thermal plasma reactor having a plurality of flat electrodes stacked in parallel, which is devised from Korean Patent No. 10-0434940, titled Catalyst reactor activated for treating hazardous gas with non-thermal plasma and dielectric heating and method treating thereof, Korean Patent No. 10-0451125, titled Noxious gas purification system using non-thermal plasma reactor and control method therefore, and Korean Patent No. 10-0454444, titled Manufacturing method of co-planar type dielectric barrier discharge reactor. However, the non-thermal plasma reactor has a problem in that, when temperature of gases to be treated is very greatly changed due to a production characteristic, either dielectric electrodes in which metal is fused between dielectrics used as electrodes or surrounding dielectrics interconnecting the dielectric electrodes are damaged by thermal shock.

Further, when the dielectric electrodes are damaged, metal surfaces exposed through the damaged dielectric electrodes are subject to local electric discharge. This causes lethal problems in that the performance of the plasma reactor is overall reduced, and the plasma generated from the plasma reactor can be no longer maintained.

Therefore, these problems of the conventional non-thermal plasma reactor occur because the dielectric electrodes having the metal electrodes in the dielectrics are fused with dielectric spacers arranged at regular intervals. More particularly, this is responsible for generation of the thermal stress caused by thermal expansion or contraction due to the extreme change of temperature.

### DISCLOSURE OF INVENTION

### Technical Problem

Accordingly, the present invention has been made to solve the above-mentioned problems occurring in the prior art, and an object of the present invention is to provide a dielectric barrier discharge flat-type non-thermal plasma reactor, capable of minimizing a damage caused by thermal stress applied while being always exposed to an environment where temperature is changed from room temperature to several hundreds of degrees C. at an exhaust system of a vehicle, and thus improving thermal stress resistant performance.

### ADVANTAGEOUS EFFECTS

In order to accomplish this object, according to an aspect of the present invention, there is provided a dielectric barrier discharge flat-type non-thermal plasma reactor having a multi-layer flat electrode, comprising a high-voltage electrode stack section applied with high-voltage power, and including a plurality of high-voltage electrode plates that are stacked at regular intervals with spacers interposed therebetween and are fused with the spacers; a ground electrode stack section connected with a ground terminal, and including a plurality of ground electrode plates spaced apart from each other so as to be interposed between the high-voltage electrode plates, and a plurality of spacers interposed between the ground electrode plates and the high-voltage electrode plates so as to allow a reaction space to be formed between the ground electrode plates and the high-voltage electrode plates; and fastening bolts having threaded ends passing through and beyond through-holes formed in the high-voltage electrode plates, the ground electrode plates of the ground electrode stack section, and the spacers respectively, fastened to combine the high-voltage electrode plates, the ground electrode plates of the ground electrode stack section, and the spacers by means of nuts, and having a relatively smaller outer diameter, compared to diameters of the through-holes, so as to play to an extent for absorbing thermal deformation between the combined high-voltage electrode plates, ground electrode plates, and spacers.

According to an aspect of the present invention, there is provided a dielectric barrier discharge flat-type non-thermal plasma reactor having a multi-layer flat electrode, comprising a high-voltage electrode stack section applied with high-voltage power, including a plurality of high-voltage electrode plates that are stacked at regular intervals with spacers interposed therebetween on opposite first and second sides thereof, and having the first side thereof which is applied with power and is fused with the spacers and the second side thereof which allows nuts to be fastened to one ends of fastening bolts that pass through and beyond through-holes formed in the spacers and high-voltage electrode plates so as to be combined with the spacers and have a relatively smaller outer diameter, compared to diameters of the through-holes, so as to play to an extent for absorbing thermal deformation between the combined high-voltage electrode plates and spacers; and a ground electrode stack section connected with a ground terminal, and including a plurality of ground electrode plates spaced apart from each other so as to be interposed between the high-voltage electrode plates, a plurality of spacers interposed between the ground electrode plates, and fastening bolts that have threaded ends, passing through and beyond through-holes formed in the ground electrode plates and the spacers respectively, fastened by nuts, and have a relatively smaller outer diameter, compared to diameters of the through-holes, so as to play to an extent for absorbing thermal deformation between the combined ground electrode plates and spacers.

According to an aspect of the present invention, there is provided a flat-type non-thermal plasma reactor having a high-voltage electrode stack section provided with a plurality of high-voltage electrode plates having metal electrodes enclosed by dielectrics and stacked at regular intervals so as to be spaced apart from each other, wherein each of the high-voltage electrode plates has a lead of each metal electrode protruding through a groove formed in each dielectric so as to be located at a different position when projected on a plane; the high-voltage electrode stack section is provided with through-holes extending from a top surface thereof to the grooves of the high-voltage electrode plates; and the though holes are filled with a conductive material that is electrically connected with external power supply and is fused by brazing so as to independently apply power to the high-voltage electrode plates.

### BRIEF DESCRIPTION OF THE DRAWINGS

The above and other objects, features and advantages of the present invention will be more apparent from the following detailed description taken in conjunction with the accompanying drawings, in which:

FIG. 1 is a sectional view illustrating a flat-type non-thermal plasma reactor according to an exemplary embodiment of the present invention;

FIG. 2 is an exploded perspective view illustrating a high-voltage electrode stack section of FIG. 1;

FIG. 3 is an exploded perspective view illustrating a ground electrode stack section of FIG. 1;

FIG. 4 is a schematic top plan view illustrating the arrangement of metal electrodes according to an exemplary embodiment of the present invention;

FIG. 5 is a partial exploded perspective view illustrating a flat-type non-thermal plasma reactor according to another exemplary embodiment of the present invention; and

FIG. 6 is a sectional view illustrating a flat-type non-thermal plasma reactor according to another exemplary embodiment of the present invention.

### EXPLANATION ON ESSENTIAL ELEMENTS OF DRAWINGS

10,110: high-voltage electrode stack section

20,70,120,170: spacers

21,31,61,69,71: holes

30,130: high-voltage electrode plates

33,65: dielectric 34:groove

35,67: metal electrodes 37: lead

50,150: ground electrode stack section

60,160: ground electrode plates

39,63,73,123,133,163,173,193: through-holes

80,135,180: fastening bolts 85,137,185: nuts

190: dummy ceramic plates

100,200: flat-type non-thermal plasma reactor

### BEST MODE FOR CARRYING OUT THE INVENTION

Hereinafter, a preferred embodiment of the present invention will be described in detail with reference to the accompanying drawings.

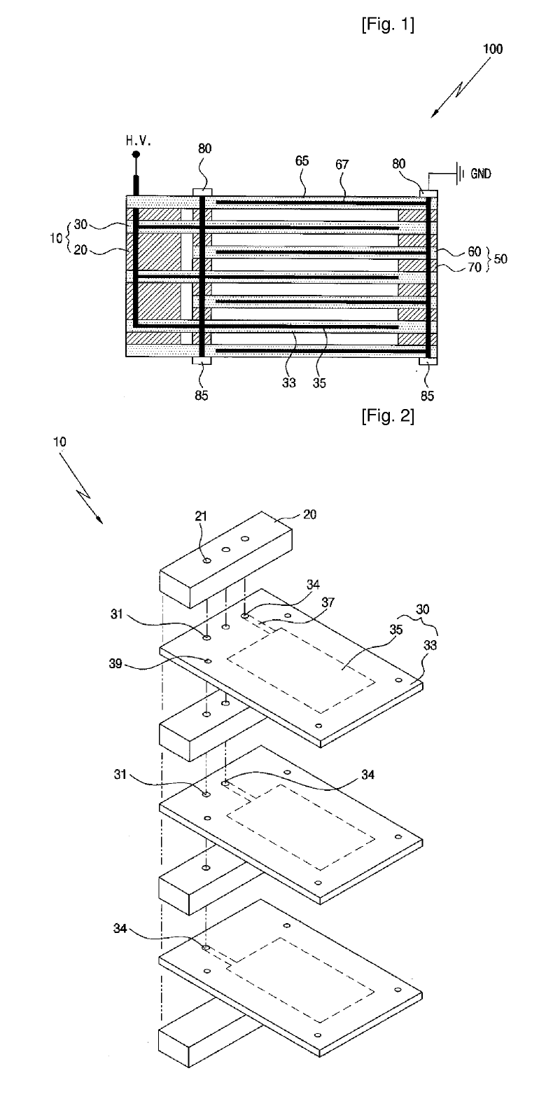

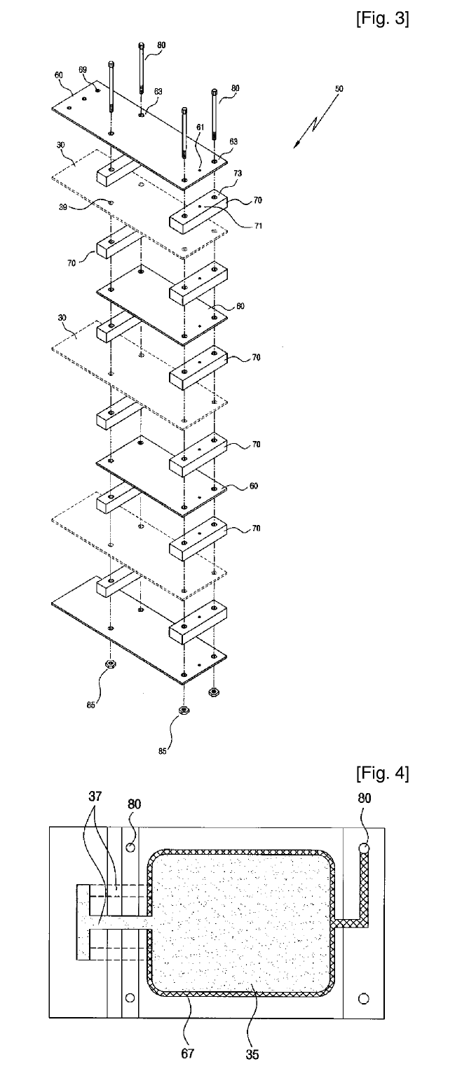

FIG. 1 is a sectional view illustrating a flat-type non-thermal plasma reactor according to an exemplary embodiment of the present invention. FIG. 2 is an exploded perspective view illustrating a high-voltage electrode stack section of FIG. 1. FIG. 3 is an exploded perspective view illustrating a ground electrode stack section of FIG. 1. FIG. 4 is a schematic top plan view illustrating the arrangement of metal electrodes according to an exemplary embodiment of the present invention.

As illustrated, the flat-type non-thermal plasma reactor 100 of the present invention is a dielectric barrier discharge flat-type non-thermal plasma reactor having multilayer flat electrodes, and includes a high-voltage electrode stack section 10 and a ground electrode stack section 50.

The high-voltage electrode stack section 10 is applied with high-voltage power, and is constructed such that a plurality of high-voltage electrode plates 30 are fused together with spacers 20, wherein the high-voltage electrode plates 30 are stacked at regular intervals with the spacers 20 interposed therebetween.

The high-voltage electrode plates 30 are composed of a plurality of fused dielectrics 33, and metal electrodes 35 enclosed by the dielectrics 33. At this time, each dielectric 33 is formed of ceramic, and each metal electrode 35 has a lead 37 for applying power. Each high-voltage electrode plate 30 is provided with through-holes 39 through which fastening bolts pass in order to be fastened with the ground electrode stack section 50 to be described below.

A structure in which a power supply is connected to the high-voltage electrode plates 30 will be described below.

First, each high-voltage electrode plate 30 has the lead 37 of each metal electrode 35, which protrudes through a groove 34 formed in each dielectric 33.

At this time, the grooves 34 formed in the dielectrics 33 of the high-voltage electrode plates 30 are located at different positions on a plane.

Further, the high-voltage electrode stack section 10 is provided with through-holes, which extend from a top surface thereof to the grooves 34 of the high-voltage electrode plates 30. Specifically, the through-holes are holes 21 and 31 that are formed in the spacers 20 and the high-voltage electrode plates 30 in a row. Therefore, the plurality of through-holes are respectively formed to extend from the top surface of the high-voltage electrode stack section 10 to the groove 34 of each high-voltage electrode plates 30. At this time, the lengths of the through-holes are different from each other due to a stacked structure of the high-voltage electrode plates 30, and the number of the through-holes is dependent on that of the stacked high-voltage electrode plates 30. As described above, the though holes are the holes 21 and 31 formed in the spacers 20 and the high-voltage electrode plates 30 in a row, and they will not be separately indicated.

Further, the through holes are filled with a conductive material such as metal, and the conductive material in each through-hole is fused by brazing.

As such, when power is applied to the fused conductive material, the power can be independently applied to each of the high-voltage electrode plates 30.

In addition to the above-described construction, the conductive material is electrically connected with an external power supply by way of fuses (not shown). In this case, when abnormal discharge occurs, the corresponding high-voltage electrode plate 30 can be powered off.

More specifically, the conductive material fused through the through-holes, which are formed on an upper end of the planar high-voltage electrode stack section 10, is electrically connected with the external power supply, and then the fuses are individually connected on connection lines of the conductive material of the through-holes and the external power supply. Thus, when overcurrent is applied to a specific high-voltage electrode plate 30, the specific high-voltage electrode plate 30 is powered off by the corresponding fuse.

Meanwhile, the ground electrode stack section 50 is connected with a ground terminal, and includes ground electrode plates 60 spaced apart from each other so as to be interposed between the high-voltage electrode plates 30, and a plurality of spacers 70 interposed between the ground electrode plates 60 and the high-voltage electrode plates 30 so as to allow a reaction space to be formed between the ground electrode plates 60 and the high-voltage electrode plates 30.

A structure in which the high-voltage electrode stack section 10 is combined with the ground electrode stack section 50 will be described as follows.

Fastening bolts 80 pass through through-holes 63 and 73 in order to fasten the high-voltage electrode stack section 10 and the ground electrode stack section 50, wherein the through-holes 63 are formed in the high-voltage electrode plates 30 and the ground electrode plates 60 of the ground electrode stack section 50, and the through-holes 73 are formed in the spacers 70. Then, nuts 85 are fastened to threaded ends of the fastening bolts 80, respectively.

More specifically, the fastening bolts 80 and nuts 85 serve to allow the high-voltage electrode plates 30, the ground electrode plates 60, and the spacers 70 to be mechanically combined. At this time, each fastening bolt 80 is formed to have a smaller outer diameter than each of the through-holes 63 and 73, so as to play to an extent for absorbing thermal deformation at the portion where the high-voltage electrode plates 30, the ground electrode plates 60, and the spacers 70 are combined.

In this combination, preferably, some of the fastening bolts 80 fasten one ends of the high-voltage and ground electrode plates 30 and 60, while the others of the fastening bolts 80 fasten the other end of each ground electrode plate 60 at the edge of metal electrode 35 in side the each high-voltage electrode plate 30.

Further, when the high-voltage electrode stack section 10 is combined with the ground electrode stack section 50, two of the ground electrode plates 60 are preferably located on the outermost sides (i.e. on the uppermost and lowermost ends) of the high-voltage electrode stack section 10. To this end, the uppermost and lowermost ones of the ground electrode plates 60 have a relatively longer length (for combination with the spacers of the high-voltage electrode stack section) compared to the other ground electrode plates 60, and are fused with the spacers 20 of the high-voltage electrode stack section 10 on one ends thereof in the process of fusing the high-voltage electrode stack section 10. In addition, the uppermost ground electrode plate 60 is preferably formed with a plurality of holes 69 in correspondence with the holes 21 formed in the uppermost spacer of the high-voltage electrode stack section 10, thereby facilitating electrical connection to the high-voltage electrode stack section 10.

Consequently, the above-described construction can more effectively cope with thermal stress depending on use conditions to improve durability of the plasma reactor on the whole by fusing the high-voltage electrode stack section 10 to which high-voltage power is applied so as to prevent leakage of voltage from the high-voltage electrode stack section 10, and mechanically fastening the other components so as to permit the other components to be freely contracted and expanded.

Meanwhile, like the high-voltage electrode plates 30, the ground electrode plates 60 may be constructed such that metal electrodes 67 are enclosed by dielectrics 65, or be composed of merely metal plates. In the figures, the ground electrode plates 60 are illustrated as having the metal electrodes 67 enclosed by dielectrics 65. However, the ground electrode plates 60 do not require to be independently connected to a ground terminal. Hence, it is sufficient to connect each ground electrode plate 60 to the ground terminal just through a conductive material fused in a single through-hole, which is vertically formed in a row by holes 61 and 71 formed in the ground electrode plates 60 and spacers 70.

In the above-described construction, the metal electrodes 35 of the high-voltage electrode stack section 10 and the metal electrodes 67 of the ground electrode stack section 50 are preferably located only in a reaction space where a gas flow occurs, thereby preventing interference with the fastening bolts 80, and so on.

Hereinafter, another embodiment of the present invention will be described.

It should be noted that only a difference between the current embodiment and the above-described embodiment will be described and illustrated.

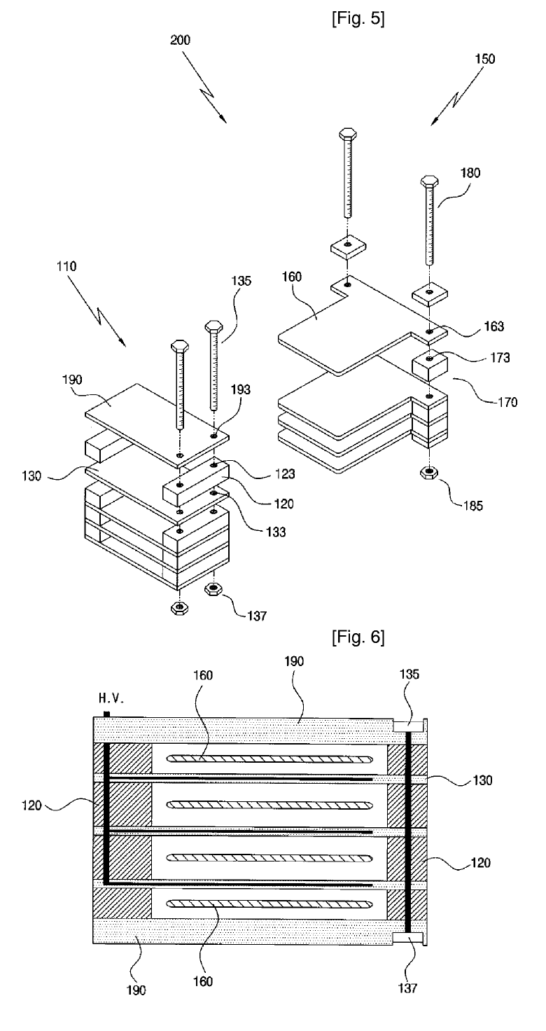

FIG. 5 is a partial exploded perspective view illustrating a flat-type non-thermal plasma reactor according to another exemplary embodiment of the present invention, and FIG. 6 is a sectional view illustrating a flat-type non-thermal plasma reactor according to another exemplary embodiment of the present invention.

In this embodiment, a flat-type non-thermal plasma reactor 200 is composed of a high-voltage electrode stack section 110 and a ground electrode stack section 150.

The high-voltage electrode stack section 110 is applied with high-voltage power, and includes a plurality of high-voltage electrode plates 130 that are stacked at regular intervals with spacers 120 interposed therebetween. Specifically, the spacers 120 are disposed on opposite left and right sides of the high-voltage electrode plates 130, when viewed from FIG. 5, so as to separate the high-voltage electrode plates 130 from each other.

At this time, the high-voltage electrode plates 130 are fused with the spacers 120 on one side thereof which is applied with power, and allow nuts 137 to be fastened to one ends of fastening bolts 135, which pass through through-holes 123 and 133 formed in the spacers 120 and high-voltage electrode plates 130, on the other side thereof, so that they are mechanically combined with the spacers 120. At this time, each fastening bolt 135 has a smaller outer diameter than diameters of the through-holes 123 and 133, so as to play to an extent for absorbing thermal deformation between the combined high-voltage electrode plates 130 and spacers 120.

The ground electrode stack section 150 is connected with a ground terminal, and includes a plurality of ground electrode plates 160 spaced apart from each other and interposed between the high-voltage electrode plates 130, and a plurality of spacers 170 interposed between the ground electrode plates 160. At this time, each ground electrode plate 160 has a shape in which its intermediate portion protrudes in one direction. Thus, when the high-voltage electrode stack section 110 is combined with the ground electrode stack section 150, the intermediate portion of each ground electrode plate 160 is interposed between the high-voltage electrode plates 130. On the basis of the protruding portion, the opposite shoulders of the ground electrode plates 160 are mechanically fastened with the spacers 170 by means of fastening bolts 180 and nuts 185.

At this time, the fastening bolts 180 pass through through-holes 163 and 173, wherein the through-holes 163 are formed in the opposite shoulders of the ground electrode plates 160, and the through-holes 173 are formed in the spacers 170. Then, the nuts 185 are fastened to threaded ends of the fastening bolts 180, respectively.

Further, the fastening bolts 180 have a smaller outer diameter than diameters of the through-holes 163 and 173, and thus play to an extent for absorbing thermal deformation of the ground electrode plates 160.

In the above-described construction, a reference numeral 190 indicates dummy ceramic plates, which are located on the uppermost and lowermost ends of the high-voltage electrode stack section 110 and prevent the high-voltage electrode plates 130 from being exposed outside.

The dummy ceramic plates 190 are fastened to the spacers 170, like the high-voltage electrode plates 130 fastened to the spacers 120. To this end, one side of each dummy ceramic plate 190 is formed with through-holes 193.

The construction of this embodiment is possible to more effectively cope with the thermal stress by completely separating the high-voltage electrode stack section 110 from the ground electrode stack section 150.

As can be seen from the foregoing, according to the present invention, the dielectric barrier discharge flat-type non-thermal plasma reactor can greatly improve durability against thermal stress, and stably generate plasma in an environment in which gases to be treated for a vehicle has a wide variation range of temperature and a great variation volume with respect to a time.

Further, unlike a conventional fusion integrated non-thermal plasma reactor formed by fusing into one body, the dielectric barrier discharge flat-type non-thermal plasma reactor separates a high-voltage electrode stack section from the ground electrode stack section while fusing minimum portions required to prevent leakage of voltage, and allows a predetermined play to be formed between combined portions. Thereby, when electrode plates are subject to different temperature variation, they can be freely expanded and contracted, and thus it is possible to effectively prevent damage of the flat-type non-thermal plasma reactor which is caused by thermal stress, such as normal stress or shear stress, depending on a different expansion ratio.

In addition, high-voltage electrode plates of the high-voltage electrode stack section are individually provided with electrode leads, overcurrent such as arc resulting from abnormal discharge is intercepted by a fuse installed to each electrode terminal. Thereby, as long as there is no problem of overall performance, electric power is not supplied to a plasma layer in which an insignificant problem occurs, and thus the flat-type non-thermal plasma reactor can extend its lifetime.

Consequently, this series of effects allows non-thermal plasma reaction technology to be easily applied to a field in which temperature of harmful gases to be treated is greatly changed, for instance an exhaust system of a vehicle in which application of the non-thermal plasma reaction technology is avoided due to a possibility of an apparatus being damaged by thermal stress, thereby to accomplish an ultimate purpose of giving a benefit to an environment.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. A dielectric barrier discharge flat-type non-thermal plasma reactor having a multi-layer flat electrode, comprising:
a high-voltage electrode stack section (10) applied with high-voltage power, and including a plurality of high-voltage electrode plates (30) that are stacked at regular intervals with spacers (20) interposed therebetween and are fused with the spacers (20);
a ground electrode stack section (50) connected with a ground terminal, and including a plurality of ground electrode plates (60) spaced apart from each other so as to be interposed between the high-voltage electrode plates (30), and a plurality of spacers (70) interposed between the ground electrode plates (60) and the high-voltage electrode plates (30) so as to allow a reaction space to be formed between the ground electrode plates (60) and the high-voltage electrode plates (30); and
fastening bolts (80) having threaded ends passing through through-holes (39, 63, 73) formed in the high-voltage electrode plates (30), the ground electrode plates (60) of the ground electrode stack section (50), and the spacers (70) respectively, fastened to combine the high-voltage electrode plates (30), the ground electrode plates (60) of the ground electrode stack section (50), and the spacers (70) by means of nuts, and having a smaller outer diameter than diameters of the through-holes (39, 63, 73), so as to play to an extent for absorbing thermal deformation between the combined high-voltage electrode plates (30), ground electrode plates (60), and spacers (70).

2. A dielectric barrier discharge flat-type non-thermal plasma reactor having a multi-layer flat electrode, comprising:
a high-voltage electrode stack section (110) applied with high-voltage power, including a plurality of high-voltage electrode plates (130) that are stacked at regular intervals with spacers (120) interposed therebetween on opposite first and second sides thereof, and having the first side thereof which is applied with power and is fused with the spacers (120) and the second side thereof which allows nuts (137) to be fastened to one ends of fastening bolts (135) that pass through through-holes (123, 133) formed in the spacers (120) and high-voltage electrode plates (130) so as to be combined with the spacers (120) and have a smaller outer diameter than diameters of the through-holes (123, 133), so as to play to an extent for absorbing thermal deformation between the combined high-voltage electrode plates (130) and spacers (120); and
a ground electrode stack section (150) connected with a ground terminal, and including a plurality of ground electrode plates (160) spaced apart from each other so as to be interposed between the high-voltage electrode plates (130), a plurality of spacers (170) interposed between the ground electrode plates (160), and fastening bolts (180) that have threaded ends, passing through through-holes (163, 173) formed in the ground electrode plates (160) and the spacers (170) respectively, fastened by nuts (185), and have a smaller outer diameter than diameters of the through-holes (163, 173), so as to play to an extent for absorbing thermal deformation between the combined ground electrode plates (160) and spacers (170).

3. The dielectric barrier discharge flat-type non-thermal plasma reactor as claimed in claim 1 or 2, wherein the high-voltage electrode plates (30, 130) comprise a plurality of dielectrics (33) fused therewith, and metal electrodes (35) enclosed by the dielectrics (33).

4. The dielectric barrier discharge flat-type non-thermal plasma reactor as claimed in claim 3, wherein the dielectrics (33) is formed of ceramic.

5. The dielectric barrier discharge flat-type non-thermal plasma reactor as claimed in claim 3, wherein:
each of the high-voltage electrode plates (30, 130) has a lead (37) of each metal electrode (35) protruding through a groove (34) formed in each dielectric (33) so as to be located at a different position when projected on a plane;
the high-voltage electrode stack section (10, 110) is provided with through-holes extending from a top surface thereof to the grooves (34) of the high-voltage electrode plates (30, 130); and
the though holes are filled with a conductive material that is electrically connected with external power supply and is fused by brazing so as to independently apply power to the high-voltage electrode plates (30, 130).

6. A flat-type non-thermal plasma reactor having a high-voltage electrode stack section (10, 110) provided with a plurality of high-voltage electrode plates (30, 130) having metal electrodes (35) enclosed by dielectrics (33) and stacked at regular intervals so as to be spaced apart from each other, wherein each of the high-voltage electrode plates (30, 130) has a lead (37) of each metal electrode (35) protruding through a groove (34) formed in each dielectric (33) so as to be located at a different position when projected on a plane;
the high-voltage electrode stack section (10, 110) is provided with through-holes extending from a top surface thereof to the grooves (34) of the high-voltage electrode plates (30, 130); and
the through holes are filled with a conductive material that is electrically connected with external power supply and is fused by brazing so as to independently apply power to the high-voltage electrode plates (30, 130).

7. The flat-type non-thermal plasma reactor as claimed in claim 5 or 6, wherein the conductive material are electrically connected with the external power supply by way of fuses, and when abnormal discharge occurs, the corresponding high-voltage electrode plate (30, 130) is powered off.
